(19) United States
(12) Patent Application Publication
(10) Pub. No.: US 2015/0294682 A1
(43) Pub. Date: Oct. 15, 2015

(54) OPTICAL INFORMATION APPARATUS

(71) Applicant: Hitachi, Ltd., Tokyo (JP)

(72) Inventors: Hideki MARUYAMA, Tokyo (JP); Kazuyoshi YAMAZAKI, Tokyo (JP); Yukinobu TANAKA, Tokyo (JP)

(21) Appl. No.: 14/685,625

(22) Filed: Apr. 14, 2015

(30) Foreign Application Priority Data
Apr. 15, 2014 (JP) 2014-083257

(51) Int. Cl. G11B 7/0065

(52) U.S. Cl. CPC G11B 7/0065

(57) ABSTRACT

In order to correct signal-to-noise ratio degradation caused by a position error of an aperture filter relative to a signal beam and ensure a high recording signal quality in an optical information apparatus using holography, an optical detection system capable of conducting position adjustment of the aperture filter by using the signal beam is provided and the aperture filter is positioned with high precision.

### INCORPORATION BY REFERENCE

The present application claims priority from Japanese application JP2014-083257 filed on Apr. 15, 2014, the content of which is hereby incorporated by reference into this application.

### BACKGROUND OF THE INVENTION

The present invention relates to an optical information apparatus using holography.

As for an optical information recording and reproducing apparatus using holography, JP-A-2008-197575 is opened to public. In JP-A-2008-197575, for example, there is description as a problem “even if a position deviation of hologram recording media with respect to a diaphragm can be corrected, an aperture diameter cannot be adjusted. Therefore, there is a problem that a trouble such as interception of a reproduced signal beam, which is originally required for reproduction, or passage of a reproduction reference beam, which exerts bad influence upon reproduction, is caused. The present invention provides a hologram apparatus capable of imaging only a reproduced signal beam required for reproduction.” Furthermore, as a solving means, there is the following description. “A hologram apparatus irradiates hologram recording media with an irradiation reference beam via a spatial light modulator, images an obtained reproduced beam with an imaging element via a condenser lens, and acquires image data. The hologram apparatus is configured to include a shading means disposed between the condenser lens and the imaging element to shade an outer edge part of the reproduced beam by a non-aperture part and pass the reproduced beam by an aperture part, a boundary identification means which generates a reference mark in a predetermined position in an optical path section of the reproduced beam and identifies a position where the reference mark is formed as an image in the image data and a position where an edge of the aperture part is formed as an image in the image data, and a position adjustment means which identifies a position deviation of the shading means on the basis of the position where the reference mark is formed as an image in the image data, and adjusts a position of the shading means to eliminate the position deviation.”

Problems of the optical information recording and reproducing apparatus using holography will now be described. As described in JP-A-2008-197575, a technique for improving the signal quality at the time of reproduction is considered. However, degradation of the recording quality caused by degradation of the signal-to-noise ratio, which is caused by a position error generated between the signal beam and the aperture filter at the time of recording, is not considered. Furthermore, the optical information recording and reproducing apparatus using holography cannot record correctly if the position relation between the aperture part and the signal beam deviates even a little. Therefore, strict setting is required. The present invention solves the above-described problems and provides a suitable optical information apparatus.

The above-described object is achieved by a configuration described below. For example, an optical information apparatus utilizing holography includes an emission unit for emitting a laser beam, an aperture filter unit including an aperture unit through which the laser beam emitted from the emission unit passes and a polarization unit for changing polarization of the laser beam, a light detection unit for detecting a light quantity of the laser beam polarized by the polarization unit in the aperture filter unit, a movement quantity calculation unit for calculating a movement quantity of the aperture filter unit depending upon the light quantity detected by the light detection unit, a current position detection unit for detecting and storing a current position of the aperture filter unit; and a control unit for moving the aperture filter unit by using the movement quantity of the aperture filter unit calculated by the movement quantity calculation unit and/or the current position of the aperture filter stored in the current position detection unit.

According to the present invention, it becomes possible to provide a suitable optical information apparatus.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of an optical information recording and reproducing apparatus;

FIG. 2 is a configuration diagram of an optical system in a pickup;

FIG. 3 is a configuration diagram of an optical system in a pickup;

FIG. 4 is a flow chart of a recording and reproducing operation;

FIG. 5 is a configuration diagram of an aperture filter;

FIG. 6 is a configuration diagram of a photodetector;

FIG. 7 is a diagram of a light receiving part of the photodetector;

FIG. 8 is an explanation diagram of a position error signal;

FIG. 9 is a configuration diagram of an aperture filter;

FIG. 10 is an installation diagram of a position detection sensor;

FIG. 11 is a flow chart of aperture filter position control;

FIG. 12 is a flow chart of aperture filter position control;

FIG. 13 is a configuration diagram of an aperture filter with position holding actuators installed;

FIG. 14 is a diagram showing a position holding method of an aperture filter with position holding actuators installed;

FIG. 15 is a configuration diagram of an aperture filter with position holding actuators installed;

FIG. 16 is a flow chart of aperture filter position control;

FIG. 17 is an explanation diagram of a position error signal; and

FIG. 18 is a flow chart of aperture filter position control.

### DESCRIPTION OF THE EMBODIMENTS

Hereafter, embodiments will be described with reference to the drawings.

### Embodiment 1

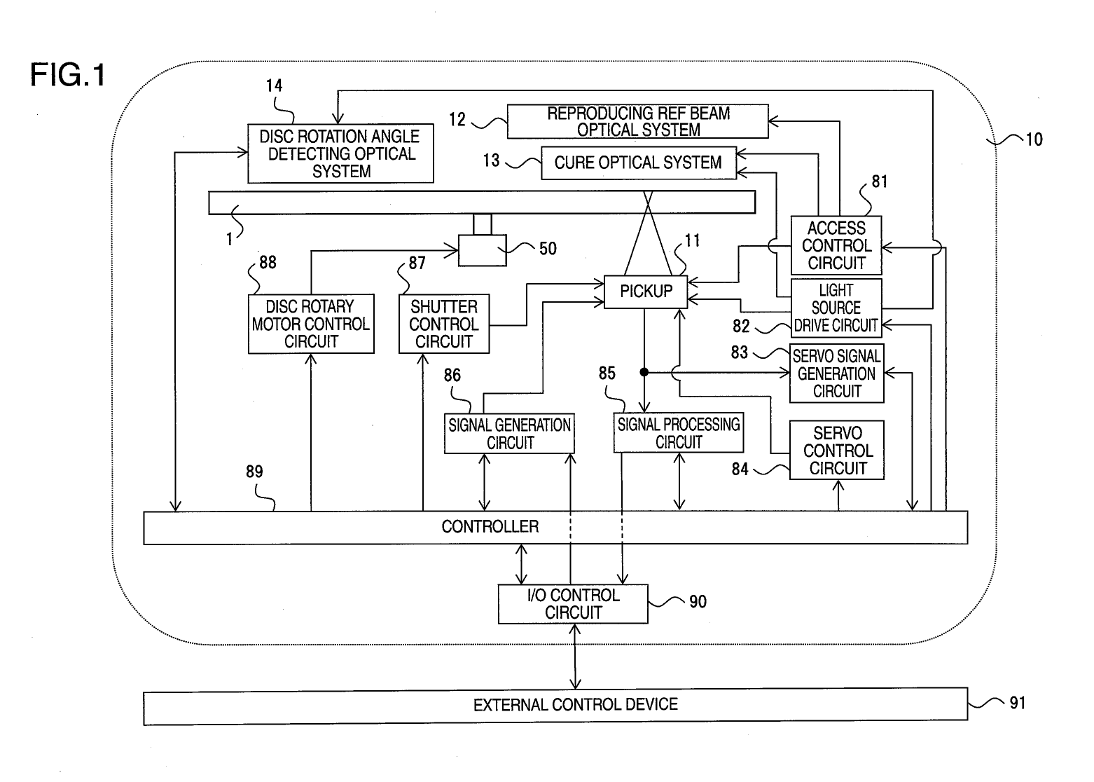

FIG. 1 is a configuration diagram of an optical information recording and reproducing apparatus using holography. An optical information recording and reproducing apparatus 10 is connected to an external control device 91 via an input/output (I/O) control circuit 90. At the time of recording, the optical information recording and reproducing apparatus 10 receives an information signal to be recorded, from the external control device 91 by using the input/output control circuit 90. At the time of reproducing, the optical information recording and reproducing apparatus 10 transmits a reproduced information signal to the external control device 91 by using the input/output control circuit 90.

The optical information recording and reproducing apparatus 10 includes a pickup 11, a reproducing reference (ref) beam optical system 12, a cure optical system 13, a disc rotation angle detecting optical system 14 and a rotary motor 50. Optical information recording media 1 taking the shape of a disc is configured to be capable of being rotated by the rotary motor 50.

The pickup 11 plays a role of emitting a reference beam and a signal beam onto the optical information recoding media 1 and recording digital information on the recording media by utilizing holography or reproducing digital information from the optical information recording media 1. An information signal to be recorded is sent into a spatial light modulator in the pickup 11 via a signal generation circuit 86 by a controller 89, and the signal beam is modulated by the spatial light modulator. When reproducing information recorded on the optical information recording media 1, the reproducing reference beam optical system 12 generates a light wave to cause the reference beam emitted from the pickup 11 to be incident on the optical information recording media in a sense opposite to that at the time of recording. An imaging element, which will be described later, in the pickup 11 detects a reproduced beam reproduced by using the reproducing reference beam. A signal processing circuit 85 reproduces a signal. The controller 89 controls open/close time of a shutter, which will be described later, in the pickup 11 via a shutter control circuit 87. As a result, irradiation time of the reference beam and the signal beam with which the optical information recording media 1 is irradiated can be adjusted.

The cure optical system 13 plays a role of generating a light beam used in precure and postcure of the optical information recording media 1. The precure is a pre-process of irradiating a desired position in the optical information recording media 1 with a predetermined light beam before irradiating the desired position with the reference beam and the signal beam when recording information in the desired position. The postcure is a post-process of irradiating a desired position in the optical information recording media 1 with a predetermined light beam to make rewriting impossible after information is recorded in the desired position.

The disc rotation angle detecting optical system 14 is used to detect a rotation angle of the optical information recording media 1. When adjusting the optical information recording media 1 to a predetermined rotation angle, the disc rotation angle detecting optical system 14 detects a signal depending upon the rotation angle and the controller 89 can control the rotation angle of the optical information recording media 1 via a disc rotary motor control circuit 88 by using the detected signal.

Furthermore, as for each of the pickup 11 and the disc cure optical system 13, a mechanism capable of sliding a position in a radial direction of the optical information recording media 1 is provided. Position control is exercised via an access control circuit 81. Or in the optical information recording and reproducing apparatus 10, a mechanism which slides the position of the optical information recording media 1 in the radial direction is provided, and position control is exercised via the access control circuit 81.

A light source drive circuit 82 supplies a predetermined light source drive current to light sources in the pickup 11, the cure optical system 13, and the disc rotation angle detecting optical system 14. Light sources can emit light beams with predetermined light quantities, respectively.

By the way, the recording technique utilizing the principle of the angular multiplexing of holography has tendency that an allowable error for deviation of an incidence angle onto the optical information storage media of the reference beam (hereafter referred to as reference beam angle) becomes extremely small.

Therefore, a mechanism for detecting a deviation quantity of the reference beam angle is provided in the pickup 11. A servo signal generating circuit 83 generates a signal for servo control. A servo mechanism for correcting the deviation quantity via a servo control circuit 84 is provided in the optical information recording and reproducing apparatus 10. Furthermore, as for the pickup 11, the cure optical system 13, and the disc rotation angle detecting optical system 14, several optical system configurations or all optical system configurations may be collected to one configuration and simplified.

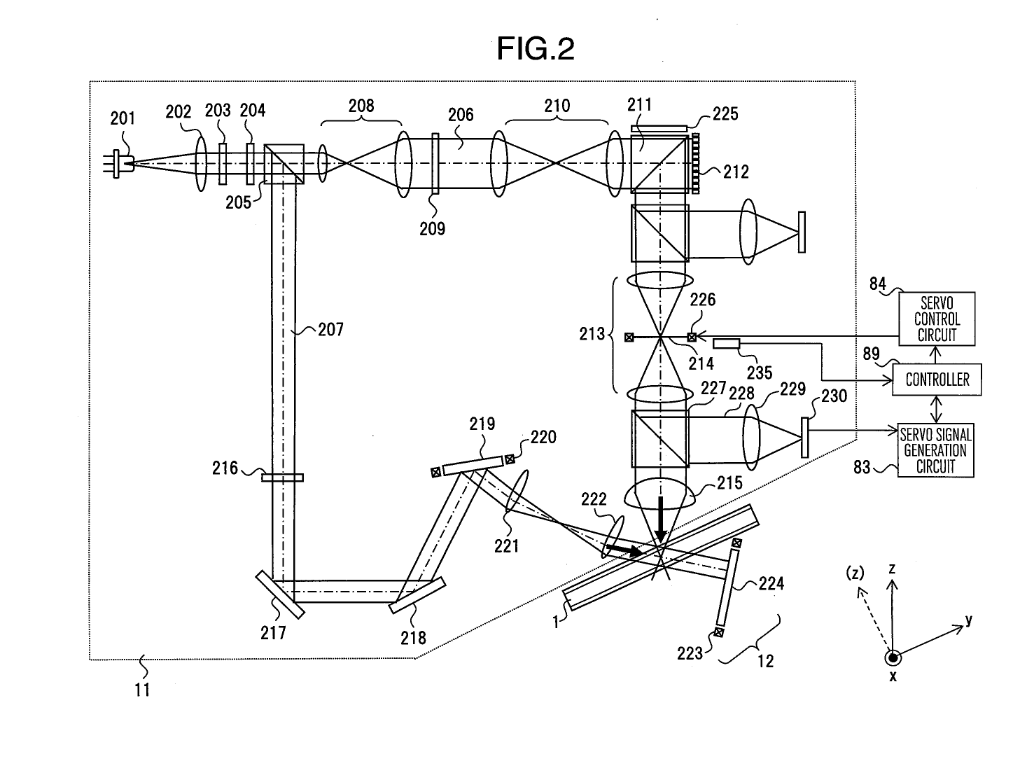

A configuration of the pickup 11 will now be described. FIG. 2 is a schematic diagram showing an example of a basic optical system configuration of the pickup 11 in the optical information recording and reproducing apparatus 10 according to the present embodiment. A recording principle will now be described with reference to FIG. 2. A light beam emitted from a light source 201 passes through a collimate lens 202 and incident on a shutter 203. When the shutter 203 is open, the light beam passes through the shutter 203. Then, the light beam is controlled in polarization direction to have a light quantity ratio between p-polarized light and s-polarized light set to a desired ratio by an optical element 204 including, for example, a half-wave plate depending upon a recording operation or a reproducing operation. Then, the light beam is incident on a polarization beam splitter 205. In the present embodiment, it is supposed that conversion to p-polarized light and s-polarized light is conducted at the time of recording, and conversion to s-polarized light is conducted at the time of reproducing.

The light beam that has passed through the polarization beam splitter 205 functions as a signal beam 206. After being expanded to a desired beam diameter by a beam expander 208, the signal beam passes through a phase mask 209, a relay lens 210 and a polarization beam splitter 211 and is incident on a spatial light modulator 212. The spatial light modulator 212 is an optical element that adds an information signal, such as two-dimensional image data, to the signal beam. For example, the spatial light modulator 212 has a configuration in which minute elements, each of which conducts polarization conversion (p-polarized light to s-polarized light), are arranged in a two-dimensional form and each element is driven depending upon an information signal to be recorded.

The signal beam 206 added with information by the spatial light modulator 212 is reflected by the polarization beam splitter 211 to propagate through an aperture filter 214 which can be adjusted in position by a relay lens 213 and actuators 226. Then, the signal beam is focused onto the optical information recording media 1 by an object lens 215. The signal beam passed through the relay lens 213 is separated to a position detecting signal beam 228 for conducting position detection of the aperture filter 214 described later, by a polarization beam splitter 227. The position detecting signal beam 228 separated from the signal beam 206 is focused by a detection lens 229, and a photodetector 230 is irradiated with the focused beam. The photodetector 230 is connected to the servo signal generating circuit 83. The servo signal generating circuit 83 generates a servo signal depending upon an output signal of the photodetector 230. The controller 89 controls the servo control circuit 84 depending upon the generated servo signal, and drives the actuators 226. When recording a hologram on the optical recording media 1, the controller 89 drives the actuators 226 depending upon the output of the photodetector 230 to control a position (for example, a position in an x-z plane) of the aperture filter 214 within a predetermined range (for example, a target position ±1 μm or less). Furthermore, a temperature sensor 235 is installed near the aperture filter 214, and the controller 89 can detect temperature near the aperture filter 214.

On the other hand, the light beam reflected by the polarization beam splitter 205 functions as a reference beam 207. The reference beam 207 is set to a predetermined polarization direction depending upon whether to conduct recording or reproducing by a polarization direction converting element 216. In the present embodiment, it is supposed that conversion to s-polarized light is conducted at the time of recording, and conversion to p-polarized light is conducted at the time of reproducing. Then, the reference beam 207 is incident on a galvanometer mirror 219 via a mirror 217 and a mirror 218. Since the galvanometer mirror 219 can be adjusted in angle by actuators 220, an incidence angle of the reference beam incident on the optical information recording media 1 after passing through a lens 221 and a lens 222 can be set to a desired angle. By the way, in order to set the incidence angle of the reference beam 207, an element that converts a wave surface may be used instead of the galvanometer mirror.

In this way, the signal beam and the reference beam are incident on the optical information recording media 1 to overlap each other. As a result, an interference fringe pattern is formed in the optical information recording media 1. Information is recorded by writing this pattern into the optical information recording media 1. Furthermore, since the incidence angle of the reference beam 207 incident on the optical information recording media 1 can be changed by the galvanometer mirror 219, recording using angular multiplexing is possible.

Hereafter, in holograms recorded in the same area with the reference beam angle changed, a hologram corresponding to each reference beam angle is referred to as “page”, and a set of pages angular-multiplexed in the same area is referred to as “book”.

After information of a predetermined quantity (page) is recorded on the optical information recording media 1, the shutter 203 is closed and information of the predetermined quantity to be recorded subsequently is displayed by the spatial light modulator 212. At the same time, the galvanometer mirror 219 is rotated by a minute quantity (for example, 0.1 degree), and the incidence angle of the reference beam 207 onto the optical information recording media 1 is changed. Then, the shutter 203 is opened. The information of the predetermined quantity to be recorded subsequently is multiplex-recorded at an angle different from the previously recorded page as a new page in the same book of the optical information recording media 1. If the number of pages arrives at a predetermined number of multiplexes (for example, 200 pages), movement to the next book is conducted. In the movement of book, the optical information recording media 1 is moved with respect to the position of the object lens 215 by a drive means, which is not illustrated. By the way, reference numeral 223 and reference numeral 226 denote actuators, reference numeral 224 denotes a galvanometer mirror, and reference numeral 225 denotes an imaging element.

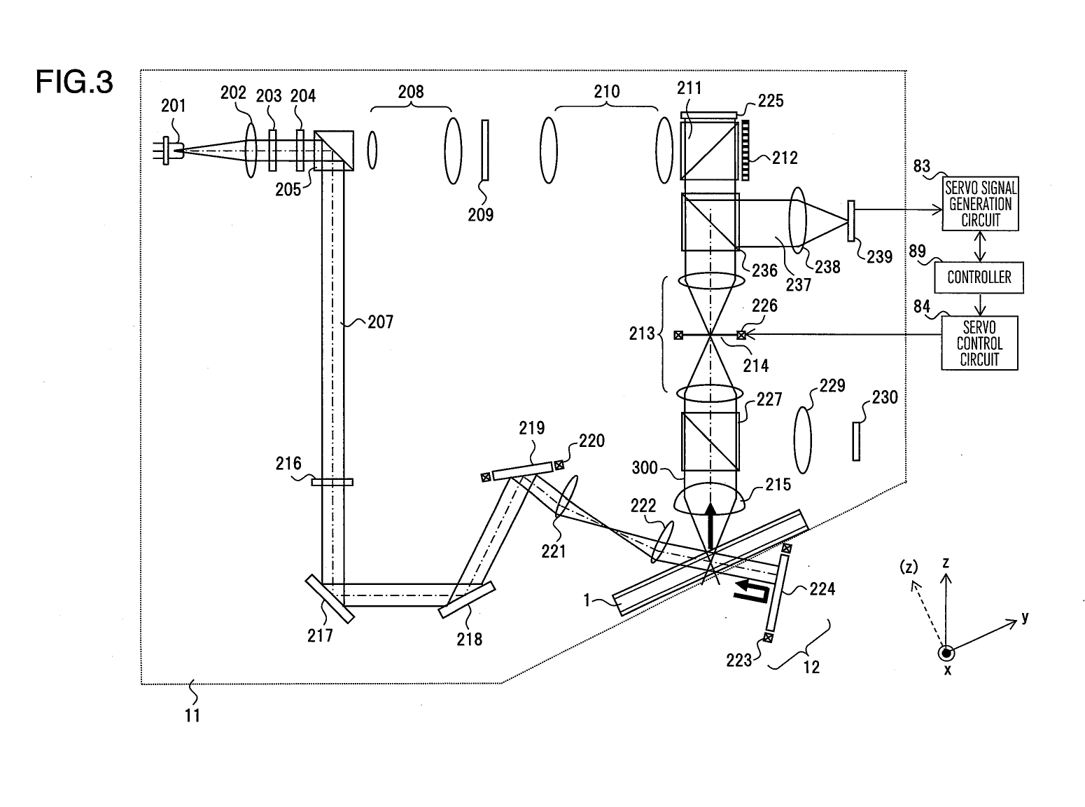

FIG. 3 is a schematic diagram showing a pickup having the same configuration as that in FIG. 2 to explain a principle of reproduction. When reproducing recorded information, the reference beam 207 is incident on the optical information recording media 1 as described above. The reference beam 207 that has passed through the optical information recording media 1 is incident on the galvanometer mirror 224, which can be adjusted in angle by actuators 223, at nearly right angles, and reflected in the opposite direction. A resultant phase conjugate beam is incident on the optical information recording media 1 again as a reproducing reference beam. By the way, the actuators 223 and the galvanometer mirror 224 constitute the reproducing reference beam optical system 12.

A reproduced beam 300 reproduced by using the reproducing reference beam propagates through the object lens 215, the relay lens 213 and the aperture filter 214, which can be adjusted in position by the actuator 226. Then, the reproduced beam 300 passes through the polarization beam splitter 211, and incident on the imaging element 225. As a result, the recorded signal can be reproduced. As the imaging element 225, an imaging element such as, for example, a CMOS image sensor or a CCD image sensor, can be used. However, any element may be used as long as the element can reproduce page data.

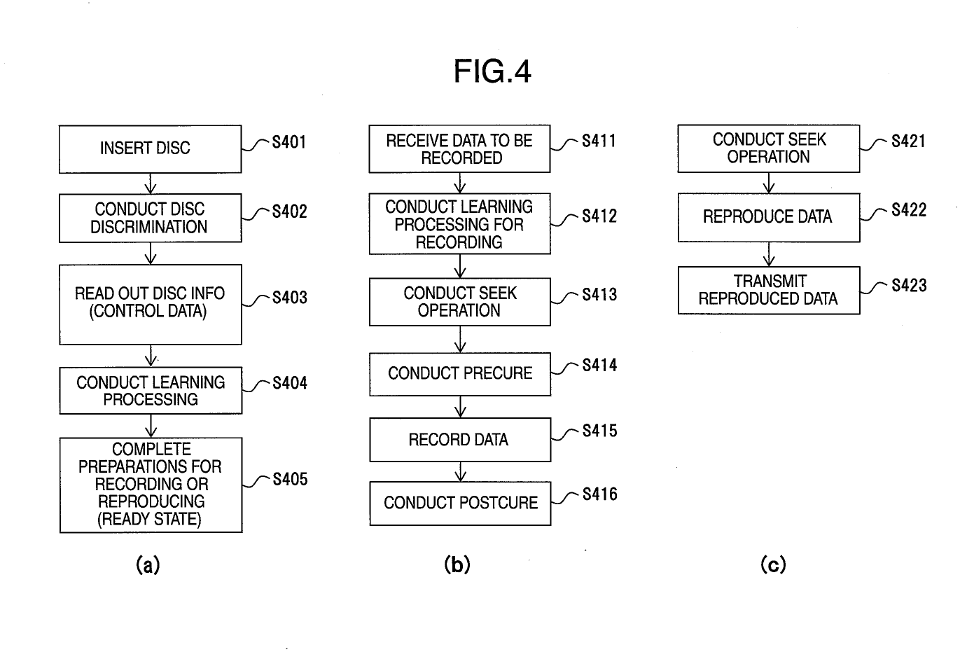

An operation flow of recording and reproducing will now be described. FIG. 4 shows an operation flow of recording and reproducing in the optical information recording and reproducing apparatus 10. Here, especially a flow concerning an operation of recording and reproducing utilizing holography will be described.

FIG. 4(a) shows a flow of operation conducted until preparations for recording or reproducing are completed since the optical information recording media 1 is inserted into the optical information recording and reproducing apparatus 10. FIG. 4(b) shows a flow of operation conducted until information is recorded on the optical information recording media 1 since a state in which the preparations are completed. FIG. 4(c) shows a flow of operation conducted until information recorded on the optical information recording media 1 is reproduced since the state in which the preparations are completed.

As shown in FIG. 4(a), the optical information recording media 1 is inserted (S401). The optical information recording and reproducing apparatus 10 conducts optical information recording media discrimination to determine whether, for example, the inserted optical information recording media 1 is optical information recording media on which recording or reproducing of digital information is conducted utilizing holography (S402).

If it is determined as a result of the optical information recording media discrimination that the inserted optical information recording media is optical information recording media on which recording or reproducing of digital information is conducted utilizing holography, the optical information recording and reproducing apparatus 10 reads out control data provided on the optical information recording media 1 (S403). The optical information recording and reproducing apparatus 10 acquires, for example, information concerning the optical information recording media 1 and, for example, information concerning various setting conditions at the time of recording or reproducing. By the way, in the case of an optical information recording and reproducing apparatus dedicated for holography, the discrimination step (S402) may be omitted.

After reading the control data, the optical information recording and reproducing apparatus 100 conducts various adjustments depending upon the control data and learning processing concerning the pickup 11 (S404), and completes preparations for recording or reproducing (S405).

The flow of operation conducted until information is recorded since the preparation completion state is shown in FIG. 4(b). First, the optical information recording and reproducing apparatus 100 receives data to be recorded (S411), and sends information depending upon the data into the spatial light modulator 212 in the pickup 11.

Then, the optical information recording and reproducing apparatus 100 previously conducts various kinds of learning processing for recording in order to make it possible to record high quality information on the optical information recording media 1 (S412). The optical information recording and reproducing apparatus 100 previously conducts, for example, power optimization of the light source 201, optimization of exposure time using the shutter 203, and positioning of the aperture filter 214 by driving the actuator 226 with the servo control circuit 84 depending upon the output of the photodetector 230, as occasion demands.

Then, in seek operation (S413), the optical information recording and reproducing apparatus 10 controls the access control circuit 81 to position the pickup 11 and the cure optical system 13 in predetermined positions on the optical information recording media 1. Then, the optical information recording and reproducing apparatus 10 precures a predetermined area by using the light beam emitted from the cure optical system 13 (S414), and records data by using the reference beam and the signal beam emitted from the pickup 11 (S415). After recording data, the optical information recording and reproducing apparatus 10 conducts postcure by using the light beam emitted from the cure optical system 13 (S416). The optical information recording and reproducing apparatus 10 may verify data as occasion demands.

The flow of operation conducted until information is reproduced since the preparation completion state is shown in FIG. 4(c). First, in seek operation (S421), the optical information recording and reproducing apparatus 10 controls the access control circuit 81 to position the pickup 11 and the reproducing reference beam optical system 12 in predetermined positions on the optical information recording media. Then, the optical information recording and reproducing apparatus 10 emits the reference beam from the pickup 11, reads out information recorded on the optical information recording media (S422), and transmits reproduced data (S423).

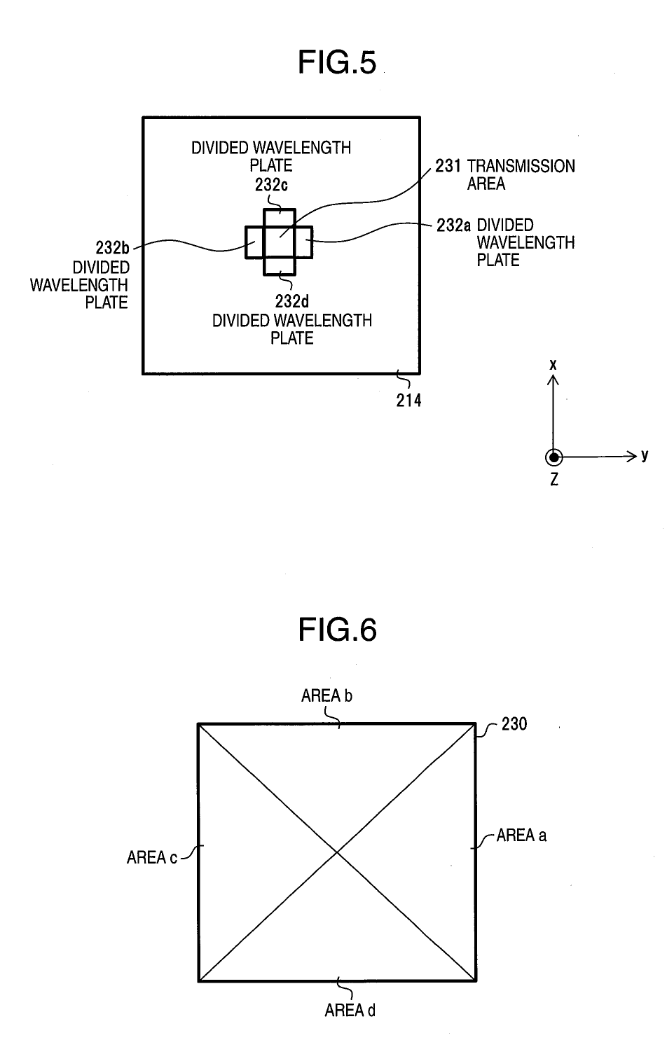

A detailed configuration for detecting the position of the aperture filter 214 will now be described. Here, position detection means detection of a relative position of the aperture filter 214 relative to the signal beam 206 shown in FIG. 2. Hereafter, as shown in FIG. 2, a recording/reproducing direction of a book on the optical information recording media 1 (in the case of a disc, for example, a circumference direction) is referred to as x direction. A direction (radius direction) perpendicular to the x direction in a plane of the optical information recording media 1 is referred to as y direction. An optical axis direction (focus direction) of the aperture filter 214 or a vertical direction of the optical information recording media 1 is referred to as z direction. Position error signals for respective directions are denoted by SX, SY and SZ. FIG. 5 shows a configuration of the aperture filter 214 viewed from the imaging element 225 side. A transmission area 231 through which the signal beam passes is located in a center of the aperture filter 214. Divided wavelength plates 232a, 232b, 232c and 232d are disposed around the transmission area 231. The divided wavelength plates are disposed to be irradiated with the signal beam in a case where a position error occurs in the aperture filter 214 relative to the signal beam.

As shown in FIG. 2, the signal beam 206 is passed through the aperture filter 214 and focused by the object lens 215. The optical information recording media 1 is irradiated with the focused signal beam 206. The divided wavelength plates 232a, 232b, 232c and 232d shown in FIG. 5 are irradiated with the beam only when a position error occurs in the aperture filter 214 relative to the signal beam as described above. The divided wavelength plates 232a, 232b, 232c and 232d are not restricted to four divided shapes as shown in FIG. 5. For example, an integral shape surrounding the periphery of the transmission area 231 completely may be used. The beam with which the divided wavelength plates 232a, 232b, 232c and 232d are irradiated is separated to the position detecting signal beam 228 for conducting position detection of the aperture filter 214 by the polarization beam splitter 227. The position detecting signal beam 228 separated from the signal beam 206 is focused by the detection lens 229, and the photodetector 230 is irradiated with the focused beam. FIG. 6 is a configuration diagram of the photodetector 230. The photodetector 230 is divided into four areas a, b, c and d. In respective areas, signals are output depending upon the light quantities. It is sufficient that independent signal outputs are obtained from respective areas. Besides the method of dividing a single photodetector into four areas as shown in FIG. 6, therefore, for example, a method of disposing one photodetector every area may be used. Furthermore, a PD (Photo Detector) can be used as the photodetector. However, the photodetector is not restricted to the PD as long as an output depending upon the light quantity is obtained.

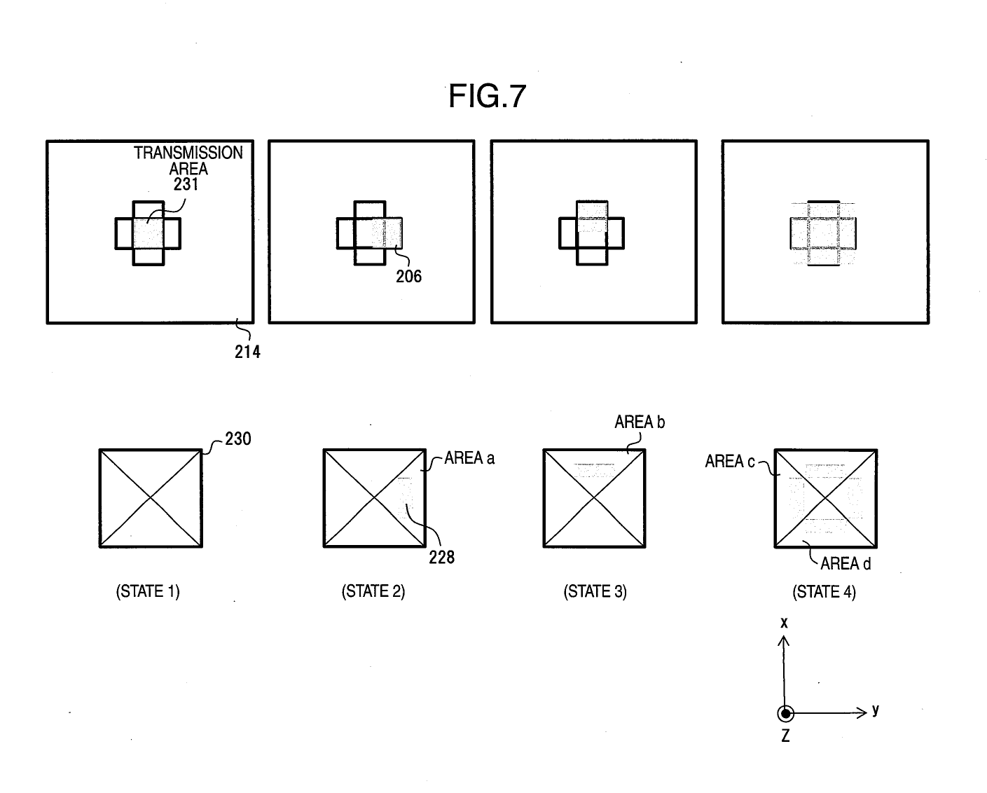

FIG. 7 shows position relations of the signal beam 206 and beam receiving states in the photodetector at that time. (State 1) in FIG. 7 indicates a state in which the signal beam 206 passes through the transmission area 231. In this case, the aperture filter 214 is in a position where a position error relative to the signal beam 206 falls in a predetermined range. The photodetector 230 is not irradiated with the position detecting signal beam 228. In this state, a signal is not output from any of the areas a, b, c and d of the photodetector. (State 2) indicates a state in which a position error of the aperture filter 214 relative to the signal beam 206 exceeds the predetermined range in the y direction. In this state, the area “a” of the photodetector 230 is irradiated with the position detecting signal beam 228. (State 3) indicates a state in which a position error of the aperture filter 214 relative to the signal beam 206 exceeds the predetermined range in the x direction. In this state, the area c of the photodetector 230 is irradiated with the position detecting signal beam 228. (State 4) indicates a state in which a position error of the aperture filter 214 relative to the signal beam 206 exceeds the predetermined range in the z direction. In this state, all of the areas a, b, c and d of the photodetector 230 is irradiated with the position detecting signal beam 228.

Signals obtained from the areas a, b, c and d of the photodetector 230 are denoted by A, B, C and D, respectively. Position error signals SX, SY and SZ are obtained, for example, according to the following equations, respectively.

SX=A−C (equation 1)

SY=B−D (equation 2)

SZ=A+B+C+D (equation 3)

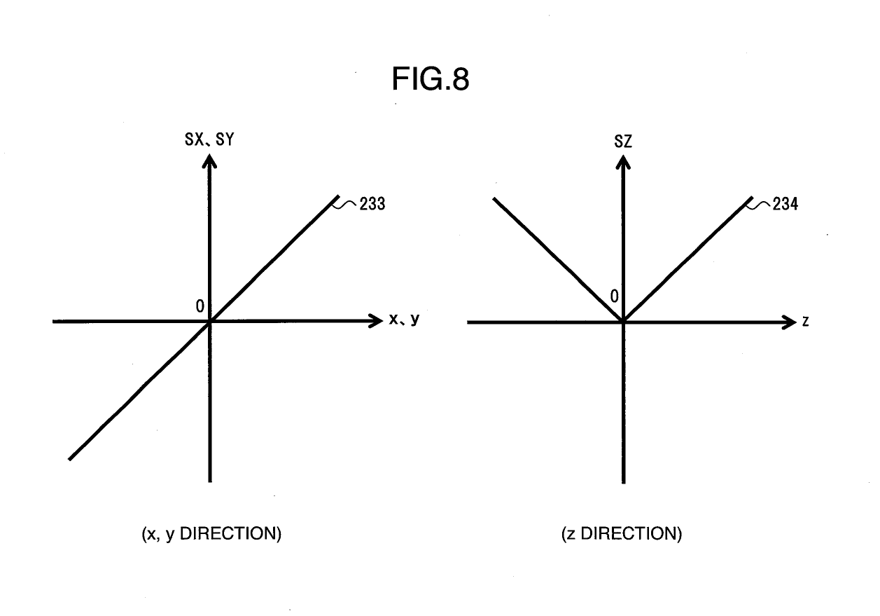

Calculation of the positions error signals is conducted by, for example, the servo signal generation circuit 83 in the optical information recording and reproducing apparatus. The calculated result becomes, for example, a position error signal indicating a position error in the x direction (circumference direction) in (state 2) in FIG. 7, indicating a position error in the y direction (radius direction) in (state 3), and indicating a position error in the z direction (focus direction) in (state 4). FIG. 8 shows relations between the position error and the position error signal. As shown in (x, y) direction in FIG. 8, an x, y direction position error signal 233 becomes a straight line as a function of the position error. On the other hand, a z direction position error signal 234 becomes a V shaped as a function of the position error as shown in (z direction) in FIG. 8. Positioning of the aperture filter 214 is conducted by driving the actuators 226 with the servo control circuit 84 to cause the calculated position error signals SX, SY and SZ to approach 0.

Owing to such position control, it becomes possible to control the position (for example, the position in the x-z plane) of the aperture filter 214 into a predetermined range (for example, the target position ±1 μm or less) with high precision. It is supposed that, for example, some optical position deviation occurs and a position error exceeding a predetermined range occurs in the aperture filter 214 relative to the signal beam 206. In this case, the servo control circuit 84 drives the actuators 226 depending upon the output of the photodetector 230 and thereby control the position of the aperture filter 214 with high precision to cause the position error to fall within a predetermined range. Owing to the high precision position control of the aperture filter, it becomes possible to correct degradation of the signal-to-noise ratio of the signal beam at the time of recording. It is possible to cause, for example, the servo control circuit 84 to store data of the position error signal in response to an instruction from the controller 89. By doing so, it is also possible to read out a previously stored position error signal and control the position of the aperture filter 214 on the basis of the position error signal read out.

As the actuators, for example, a voice coil motor can be utilized. However, the actuators need only to be able to drive the aperture filter depending upon the output of the photodetector. Therefore, the actuators is not restricted to the voice coil motor, but a stepping motor or a piezo element can also be used. Furthermore, it is not always necessary to exercise control on all of the x axis, the y axis, and the z axis. As for an axis for which influence of an position error of the aperture filter relative to the signal beam is relative slight, control on the axis can be omitted to, for example, simplify the configuration (reduce the size, and lower the cost).

Heretofore, position control of the aperture filter relative to the signal beam has been described. The optical information recording media 1 is irradiated with the reference beam 207 as shown in FIG. 3, and a resultant beam is reflected by the reproducing reference beam optical system 12 and passed through the object lens 215. For a resultant beam, the position error detecting optical system for the aperture filter 214 for the signal beam described heretofore is provided. As a result, position control of the aperture filter 214 relative to the optical information recording media 1 becomes possible. In other words, the reference beam 207 passed through the relay lens 213 is separated to a position detecting signal beam 237 for conducting position detection of the aperture filter 214 by a polarization beam splitter 236. The position detecting signal beam 237 separated from the reference beam 207 is focused by a detection lens 238, and a photodetector 239 is irradiated with the focused beam. The photodetector 239 is connected to a servo signal generating circuit 83. The servo signal generating circuit 83 generates a servo signal depending upon an output signal of the photodetector 239. A controller 89 controls the servo control circuit 84 depending upon the generated servo signal and drives the actuators 226. Owing to such a configuration, it is possible to implement a configuration capable of controlling the position of the aperture filter by using the signal beam (beam from the imaging element 225)/the reference beam (beam from the optical information recording media 1).

According to the present embodiment described heretofore, it is possible to provide an optical information recording and reproducing apparatus that can correct degradation of the signal-to-noise ratio in the signal beam.

### Embodiment 2

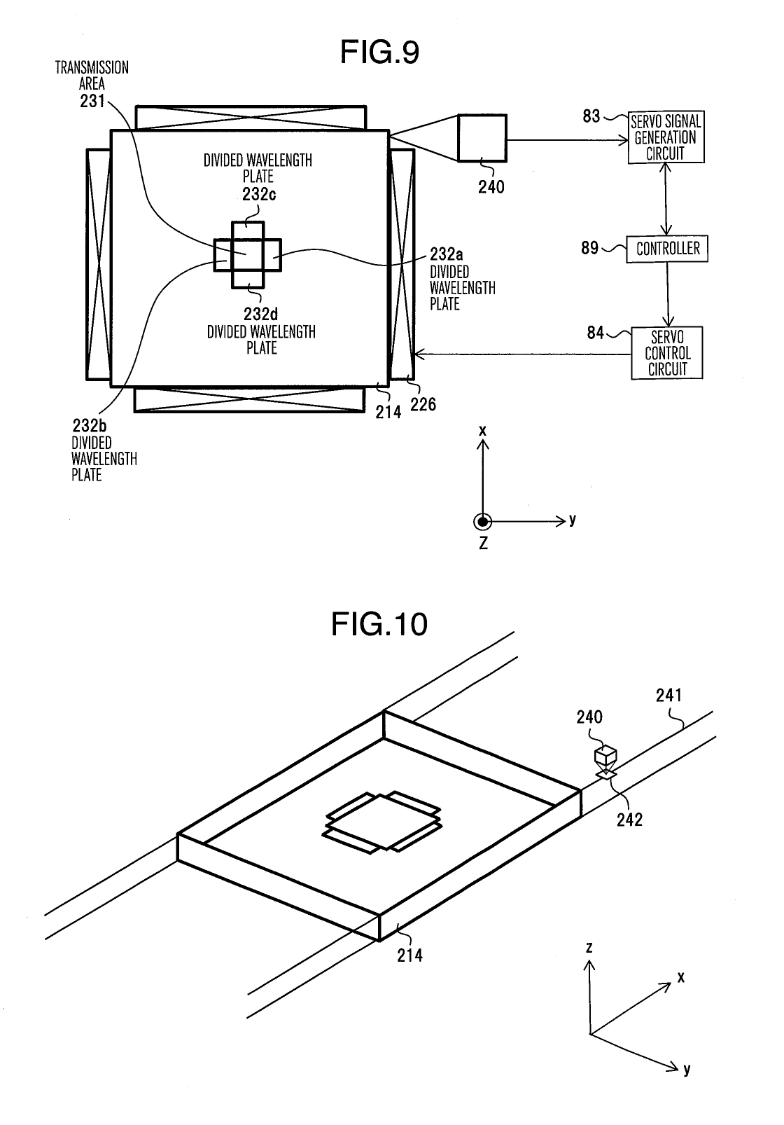

Position control is exercised to locate the aperture filter 214 in a position where the position error of the aperture filter falls within a predetermined range (for example, 5 μm or less) by using the position detecting signal beam 228. Then, a signal of a position detecting sensor 240, which detects the position of the aperture filter 214, is utilized. FIG. 9 is a configuration diagram in which the position detecting sensor 240 is installed for the aperture filter 214. In the aperture filter 214, divided wavelength plates 232a, 232b, 232c and 232d are disposed around a transmission area 231. In addition, the position detecting sensor 240 is installed to be capable of detecting the position of the aperture filter 214. The position detecting sensor 240 is connected to the servo signal generating circuit 83. The servo signal generating circuit 83 generates a servo signal depending upon the photodetector 230. The controller 89 controls the servo control circuit 84 depending upon the generated servo signal, and drives the actuators 226. The position detecting sensor 240 in the present embodiment needs only to detect the position error of the aperture filter in the x, y and z axes. The position detecting sensor 240 can be implemented by using, for example, a PSD (Position Sensitive Detector). However, the position detecting sensor 240 may be a sensor or an element, such as, for example, a magnetic sensor as long as it is capable of detecting the position error of the aperture filter 214.

Here, the position detecting sensor 240 is installed to detect the position of the aperture filter 214 directly. However, a configuration described hereafter may be used. FIG. 10 is a configuration diagram in which a position detecting sensor is installed on a wire suspension. A voice coil motor is used as an example of the actuators of the aperture filter 214, and the aperture filter 214 is hung by a wire suspension 241. It becomes possible to detect the position of the aperture filter 214 equivalently by providing a position detecting mirror 242 on a part of the wire suspension 241 and detecting a position of the position detecting mirror 242 with a position detecting sensor 240.

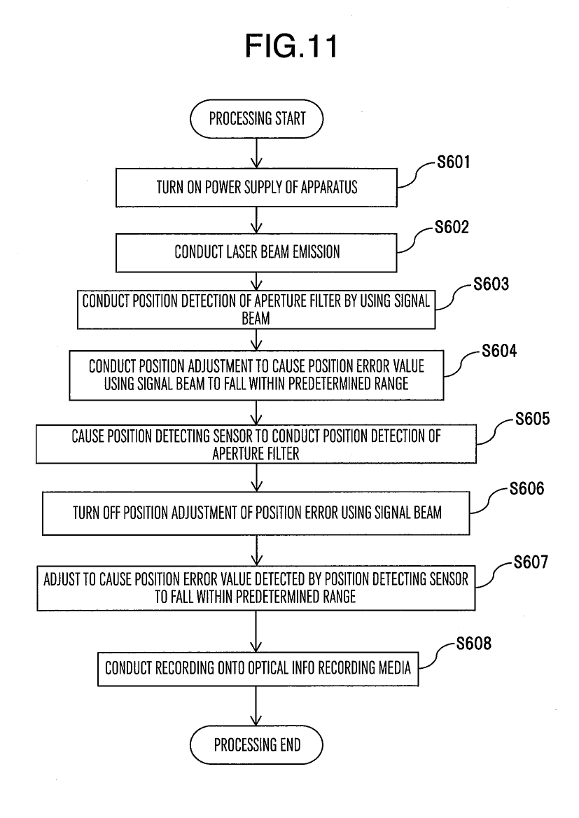

A control procedure using position detection using a position detecting signal beam and position detection using a position detecting sensor will now be described with reference to a flow chart. As shown in FIG. 11, first a power supply of the apparatus is turned on (S601), before recording onto the optical information recording media 1. Subsequently, laser beam emission is conducted (S602) to prepare for position adjustment, which causes the position error of the aperture filter to fall within the predetermined range by using the signal beam 206. Then, the photodetector 230 conducts position detection of the aperture filter by using the signal beam 206 (S603). In addition, the photodetector 230 is connected to the servo signal generating circuit 83 as shown in FIG. 2. The servo signal generating circuit 83 generates a servo signal depending upon an output signal of the photodetector 230. The controller 89 controls the servo control circuit 84 depending upon the generated servo signal and controls the actuators 226 to a position where the output of the photodetector 230 falls within a predetermined range as shown in FIG. 8 to conduct position adjustment (S604). Subsequently, as shown in FIG. 9, the position detecting sensor 240 conducts position detection of the aperture filter 214 (S605). Subsequently, the position adjustment using the signal beam is turned off (S606). The position detecting sensor 240 is connected to the servo signal generating circuit 83. The servo signal generating circuit 83 generates a servo signal depending upon an output signal of the position detecting sensor 240. The controller 89 controls the servo control circuit 84 depending upon the generated servo signal and controls the actuators 226 to adjust the position (S607). Thereafter, recording onto the optical information recording media 1 is conducted in a state of position adjustment in which a position error detected by the position detecting sensor 240 falls within a predetermined range (S608). Owing to the control procedure described heretofore, it is possible to provide an optical information recording and reproducing apparatus that can correct degradation of the signal-to-noise ratio of the signal beam and that is higher in reliability as compared with embodiment 1.

### Embodiment 3

In embodiment 2, the polarization beam splitter 227 generates the position detecting signal beam 228 for detecting the position of the aperture filter 214 as shown in FIG. 2. The position control of the aperture filter 214 is exercised by using the signal of the photodetector 230. Then, position control of the aperture filter 214 is exercised by using the signal of the position detecting sensor 240. Here, it is possible to provide a further simplified optical information recording and reproducing apparatus by implementing a simple optical system according to a method described hereafter. The position error of the aperture filter 214 relative to the position detecting signal beam 228 is caused mainly by attachment precision of the optical system. Therefore, the position error does not always change depending upon the state of the optical information recording media 1.

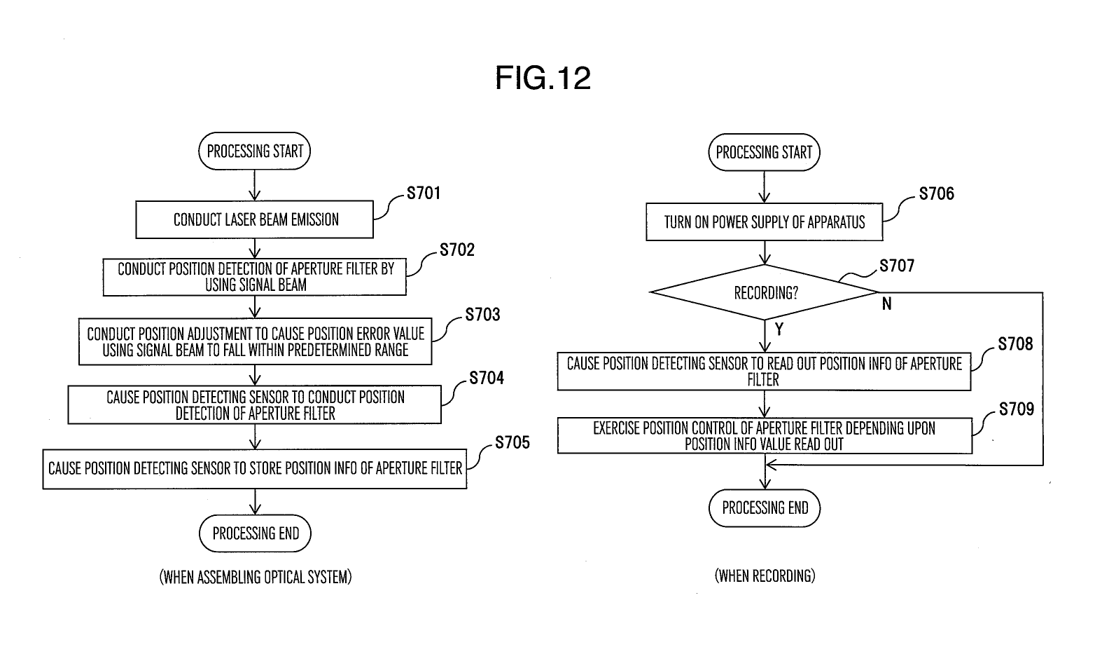

On the other hand, if the whole of the optical information recording and reproducing apparatus 10 undergoes vibration or shock, there is a possibility that a position error of the aperture filter 214 relative to the signal beam 206 will occur. Therefore, a position of the aperture filter 214 where a position error falls in a predetermined range is found previously by using the position detecting signal beam 228. A signal of the position detecting sensor 240 is acquired about the position of the aperture filter 214. Position adjustment is conducted using this. A control procedure of position detection using the position detecting sensor 240 will now be described with reference to a flow chart. As shown in (when assembling optical system) in FIG. 12, laser beam emission is first conducted (S701) to prepare for position adjustment that causes the position error of the aperture filter 214 to fall within a predetermined range. Then, the photodetector 230 conducts position detection of the aperture filter 214 by using the signal beam 206 (S702). In addition, the photodetector 230 is connected to the servo signal generating circuit 83 as shown in FIG. 2. The servo signal generating circuit 83 generates a servo signal depending upon an output signal of the photodetector 230. The controller 89 controls the servo control circuit 84 depending upon the generated servo signal and controls the actuators 226 to locate the aperture filter 214 in a position where the output of the photodetector 230 falls within a predetermined range as shown in FIG. 8 to conduct position adjustment (S703).

In this state, the position detecting sensor 240 conducts position detection of the aperture filter 214 as shown in FIG. 9 (S704). The servo control circuit 84 can store data of the position error signal in response to an instruction from the controller 89. Therefore, the servo control circuit 84 executes storage of the value of the position detecting sensor 240 (S705). The value of the position detecting sensor 240 becomes the position of the aperture filter 214 where the position error falls within a predetermined range. After the assembly of the optical system is finished, the polarization beam splitter 227, the detection lens 229, and the photodetector 230 become unnecessary, and consequently they can be removed. Therefore, it becomes possible to utilize them only when assembling the optical system and the optical system can be simplified (resulting in space saving and a lower cost). At the time of recording, the power supply of the apparatus is turned on (S706) as shown in (when recording) in FIG. 12. In the case of recording onto the optical information (info) recording media 1 (Y in S707), the controller 89 instructs the servo control circuit 84 to read out the value of the position detecting sensor 240 stored in the servo control circuit 84 (S708).

The servo control circuit 84 controls the actuators 226 by using the position information read out and exercises adjustment control of the position of the aperture filter 214 (S709). Thereafter, position information of the position detecting sensor 240 is monitored at determinate periods. Even if vibration or shock occurs in the whole of the optical information recording and reproducing apparatus 10, therefore, it becomes possible to control the aperture filter 240 to a position where the position error falls within a predetermined range by controlling the actuators of the aperture filter depending upon the position information of the position detecting sensor 240. In a case where the processing is not recording onto the optical information recording media 1 (N in S707), the processing is immediately finished.

Owing to the flow described heretofore, it is possible to provide an optical information recording and reproducing apparatus capable of adjusting degradation of the signal-to-noise ratio of the signal beam with a simplified optical system.

### Embodiment 4

In embodiment 2 or 3, position control of the aperture filter is exercised depending upon the output of the photodetector or the position detecting sensor. Occurrence of the position errors of the signal beam and the aperture filter at the time of recording is caused mainly by optical assembly. Occurrence of the position error of the aperture filter relative to the signal beam at the time of recording is caused by vibration or shock applied to the whole of the optical information recording and reproducing apparatus.

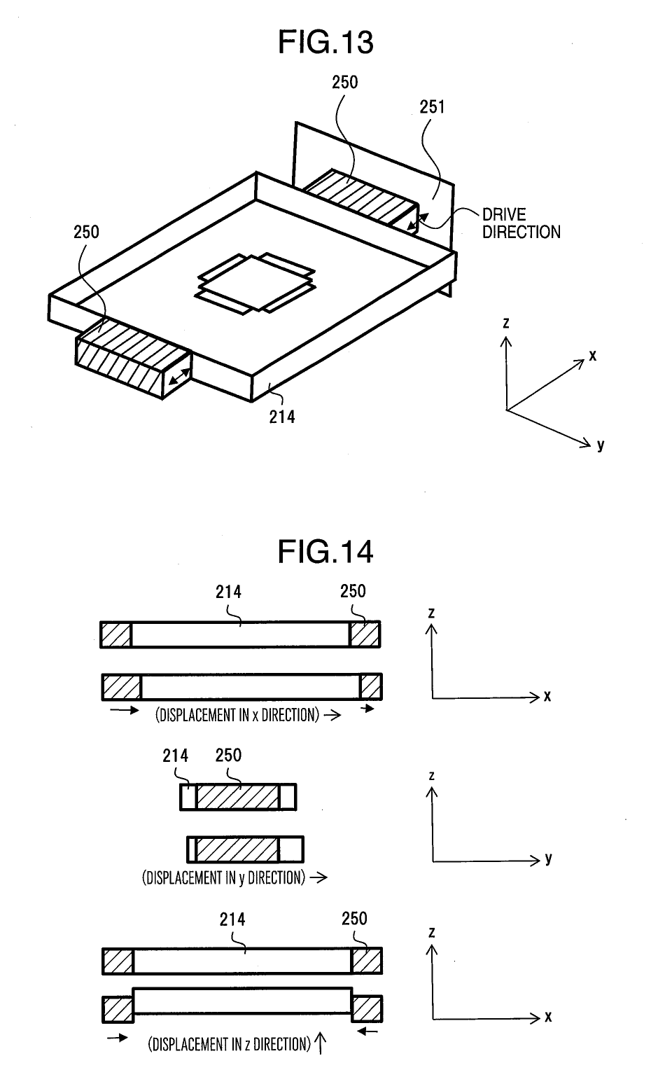

It is also conceivable to hold the aperture filter to prevent it from moving even if the whole of the optical information recording and reproducing apparatus is subject to vibration or shock, once the position of the aperture filter is controlled by the actuators to become a position where the position error falls within a predetermined range. FIG. 13 is a configuration diagram in which a position holding actuators 250 is installed to hold the aperture filter 214.

The position holding actuators 250 is disposed around the aperture filter 214 to hold it. The position holding actuators 250 is disposed between a fixed part 251 and the aperture filter 214. The position holding actuators 250 is driven in a direction indicated by arrows in FIG. 13. Position control of the aperture filter 214 is exercised depending upon the drive direction of the position holding actuators 250.

In FIG. 13, two position holding actuators 250 are disposed to sandwich the aperture filter 214 between in the x axis direction as an example. FIG. 14 shows operations of the position holding actuators 250 in cases where the aperture filter 214 is displaced in x, y and z directions. A case where position holding is conducted in a position where the aperture filter 214 is displaced in the x direction in the x-z section is shown in (at the time of displacement in x direction) in FIG. 14. In this case, one of the two position holding actuators 250 is driven in a direction to extend in the x direction whereas the other is driven in a direction to shrink in the x direction and consequently the aperture filter 214 is held.

A case where the position of the aperture filter 214 is held in a position displaced in the y direction in the y-z section, by actuators which are not illustrated is shown in (at the time of displacement in y direction) in FIG. 14. In this case, the position holding actuators 250 hold the aperture filter 214 by driving the aperture filter 214 to compress it in the x direction, which is not illustrated. A case where the position of the aperture filter 214 is held in a position displaced in the z direction in the x-z section, by actuators which are not illustrated is shown in (at the time of displacement in z direction) in FIG. 14. In this case, the position holding actuators 250 hold the aperture filter 214 by driving the aperture filter 214 to compress it in the x direction. It becomes possible to hold the aperture filter 214 in the x, y and z directions by installing the position holding actuators 250 to sandwich the aperture filter 214 between them.

A form in the case where two position holding actuators are disposed to sandwich the aperture filter in the x-axis direction has been described as an example. However, position holding can also be implemented by disposing two position holding actuators to sandwich the aperture filter, for example, in the y direction.

In the case where two position holding actuators are provided with respect to the x, y and z axes, which are drive directions of the aperture filter, along an axis, the contact area for holding between the position holding actuators and the aperture filter is small and the holding stability is lowered. However, a configuration in which the holding stability is maintained along all movable axes of the aperture filter is obtained by a form described hereafter.

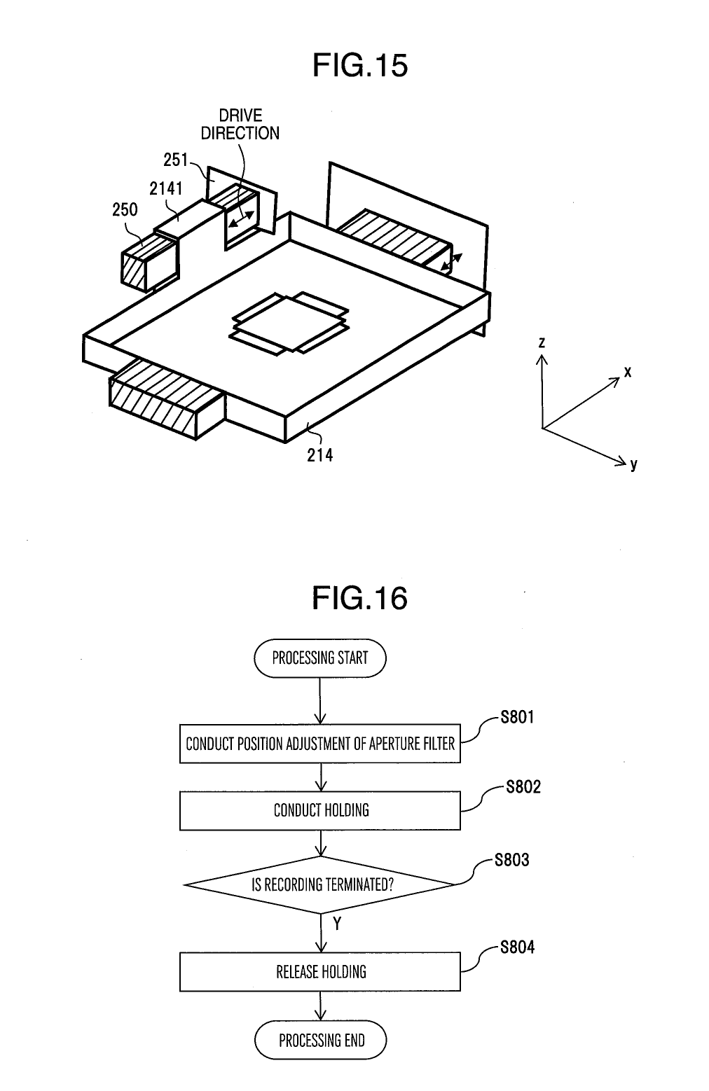

FIG. 15 is a configuration diagram in which position holding actuators are installed to hold the aperture filter. Position holding actuators 250 for holding the aperture filter 214 are disposed around a projection part 2141 of the aperture filter 214 projected in, for example, the z-direction. The position holding actuators 250 are disposed between a fixed part 251 and the aperture filter 214. The position holding actuators 250 are driven in a direction indicated by arrows in FIG. 5. Position control of the aperture filter 214 is exercised depending upon the drive direction of the position holding actuators 250.

Owing to the arrangement shown in FIG. 15, it becomes possible to ensure a sufficient contact area between the position holding actuators 250 and the aperture filter 214 even in a case where position holding is conducted in a state in which the aperture filter 214 is displaced in the z direction. Therefore, it becomes possible to ensure the holding stability along all movable axes. In a case where the position holding actuators 250 are disposed only for the z direction, holding is conducted only by the projection part 2141 of the aperture filter 214, and rotation holding force in the rotation direction around the x axis of the aperture filter 214 is weak, resulting in lowered holding stability. Therefore, it becomes possible to ensure the holding stability along all movable axes by mutual holding using the position holding actuators in the x direction described above as well.

The position holding actuator needs only to be an actuator capable of conducting position adjustment electrically or mechanically. In addition, it is desirable that the position holding actuator is a mechanism capable of holding. For example, a position holding actuator using a piezo element can be mentioned. However, the position holding actuator is not restricted to the piezo element. Owing to such a configuration, it is possible to control the position of the aperture filter to become a position where the position error falls within a predetermined range by using actuators on the basis of the signal of the photodetector or the position detecting sensor. In addition, it is possible to prevent occurrence of a position error of the aperture filter caused by vibration or shock by holding all axes at the time of recording with the position holding actuators in that state.

Subsequently, a control procedure will now be described with reference to a flow chart. FIG. 16 shows a position control flow of the aperture filter using the holding mechanism. First, position adjustment of the aperture filter is conducted according to the method described in embodiment 2 (S801). Then, holding is conducted for all axes and position holding of the aperture filter is conducted (S802). Recording is continued in this state, and recording termination is confirmed (S803). Holding is released (S804). By the way, as for the time of reproducing, the position control of the aperture filter at the time of reproducing becomes possible by using the position holding actuators 250.

Owing to the configuration described heretofore, size shrinking becomes possible as compared with embodiment 2 or 3. It is possible to provide an optical information recording and reproducing apparatus capable of correcting the signal-to-noise ratio degradation of the signal beam with simplified control without lowering the precision of the position correction.

### Embodiment 5

Position adjustment of the aperture filter with the position control executed in embodiment 4 simplified can be conducted according to a method described hereafter.

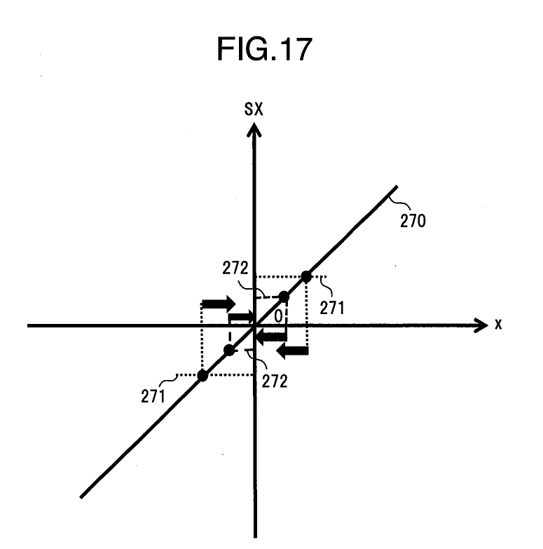

FIG. 17 shows a relation between the position error and the position error signal. In a case where a position error occurs in the x axis direction, a position error signal 270 shown in FIG. 17 occurs in the output of the photodetector or the position detecting sensor. As the position error x changes from 0, the position error signal 270 also changes from 0 as shown in FIG. 17. In a case where the position error signal 270 changes from 0, the position error of the aperture filter relative to the signal beam becomes large resulting in a lowered signal-to-noise ratio of the signal beam as described above. An allowable position error correcting threshold 271 of the position error signal is determined on the basis of degradation of the signal-to-noise ratio that can be allowed as the optical information recording and reproducing apparatus 10. The threshold may be found previously at the time of assembly of the optical system described above. In some cases, there is a large temperature difference between the time of assembly of the optical system and the time of recording. In this case, there is a difference in the actual position error between the time of assembly of the optical system and the time of recording in some cases because of temperature characteristics of the position detecting sensor and so forth even if, for example, the position error signal 270 is the same value. For example, therefore, the controller 89 shown in FIG. 2 may conduct correction depending upon temperature detected by the temperature sensor 235 shown in FIG. 2, on the position error threshold found previously to prevent the actual position error at the time of optical system assembly differing from that at the time of recording. After the position of the aperture filter 214 is controlled to a position where the position error SX falls within a predetermined range, the position is held by the position holding actuators 250. However, there is a possibility that a change will occur in the position due to vibration, shock or the like. However, position correction is not necessary as long as the position error is within the threshold described above.

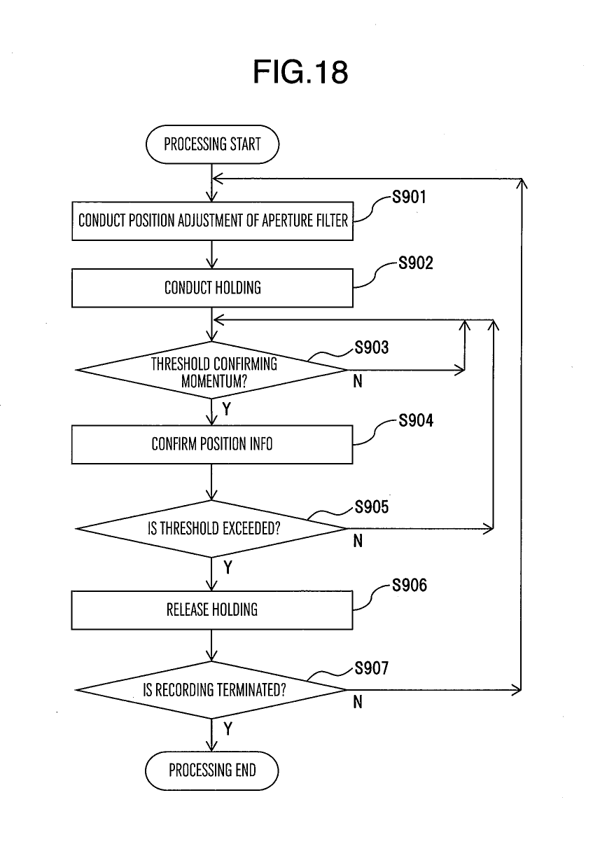

Subsequently, a control procedure will be described with reference to a flow chart. FIG. 18 shows a position adjustment flow of the aperture filter 214 using the holding mechanism. First, position adjustment of the aperture filter 214 is conducted according to the method described in embodiment 4 (S901). Then, holding is conducted for all axes and the position holding of the aperture filter 214 is conducted (S902). Recording is continued in this state. If a position error threshold confirming momentum, such as elapse of a predetermined time since recording start, occurs (Y in S903), position information is confirmed (S904). As described with reference to FIG. 17, it is determined whether the confirmed position error signal exceeds the threshold of the position error (S905).

If the threshold is exceeded (Y in S905), the holding is released (S906). Then, recording termination is confirmed (S907). If recording continuation is necessary (N in S907), the processing returns to the position adjustment of the aperture filter (S901) again. If it is determined to terminate recording (Y in S907), the processing is finished. By the way, the x axis is used in the description. However, the y axis and the z axis can be controlled in the similar processing. In other words, the x axis, the y axis and the z axis have independent thresholds, respectively. Comparison between the position error signal and the threshold is conducted in each axis. Position adjustment is conducted for only axes that require position adjustment. It is not always necessary to exercise control of position adjustment on all of the x axis, y axis and z axis. As for an axis in which influence of the position errors of the signal beam and the aperture filter is relatively slight as compared with other axes, control of position adjustment can be omitted to, for example, simplify the configuration (shrink the size and lower the cost).

In this way, it is possible to provide an optical information recording and reproducing apparatus capable of correcting the signal-to-noise degradation of the signal beam with control simplified as compared with full-time position control executed in embodiment 4.

It should be further understood by those skilled in the art that although the foregoing description has been made on embodiments of the invention, the invention is not limited thereto and various changes and modifications may be made without departing from the spirit of the invention and the scope of the appended claims.

1. An optical information apparatus utilizing holography, the optical information apparatus comprising:
an emission unit for emitting a laser beam;
an aperture filter unit including an aperture unit through which the laser beam emitted from the emission unit passes, and a polarization unit for changing polarization of the laser beam;
a light detection unit for detecting a light quantity of the laser beam polarized by the polarization unit in the aperture filter unit;
a movement quantity calculation unit for calculating a movement quantity of the aperture filter unit depending upon the light quantity detected by the light detection unit;
a current position detection unit for detecting and storing a current position of the aperture filter unit; and
a control unit for moving the aperture filter unit by using a value of at least one of the movement quantity of the aperture filter unit calculated by the movement quantity calculation unit and the current position of the aperture filter stored in the current position detection unit.

2. The optical information apparatus according to claim 1, wherein holding units for holding the aperture filter unit are provided on opposed sides of the aperture filter unit.

3. The optical information apparatus according to claim 2, wherein the holding units can move in two axis directions.

4. The optical information apparatus according to claim 3, wherein the control unit exercises control to move the holding units.

5. The optical information apparatus according to claim 1, further comprising a temperature detection unit for detecting temperature of the aperture filter unit,
wherein the control unit can perform correction depending upon the temperature.

6. The optical information apparatus according to claim 1, wherein the holding units are actuators.
